(19) United States
(12) Patent Application Publication
(10) Pub. No.: US 2024/0015750 A1
(43) Pub. Date: Jan. 11, 2024

(54) TERMINAL

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN)

(73) Assignee: NTT DOCOMO, INC., Tokyo (JP)

(21) Appl. No.: 18/035,253

(22) PCT Filed: Nov. 10, 2021
(86) PCT No.: PCT/JP2021/041391

§ 371 Date: May 3, 2023

(30) Foreign Application Priority Data
Nov. 10, 2020 (JP) 2020-187533

(51) Int. Cl. H04W 72/21; H04W 72/1268; H04W 72/566; H04L 1/00; H04W 72/23

(52) U.S. Cl. CPC H04W 72/21; H04W 72/1268; H04W 72/566; H04L 1/0067; H04W 72/23

(57) ABSTRACT

A terminal includes: a control unit that multiplexes uplink control information on an uplink shared channel; and a communication unit that transmits an uplink signal using the uplink shared channel on which the uplink control information is multiplexed. The control unit multiplies a number of bits constituting the uplink control information by a coefficient in a rate matching of the uplink control information. The control unit applies, as a range of coefficient, a specific range corresponding to a combination of a priority of the uplink control information and a priority of the uplink shared channel.

### TECHNICAL FIELD

The present disclosure relates to terminals that perform radio communication, particularly terminals that perform multiplexing of uplink control information for an uplink shared channel.

### BACKGROUND ART

The 3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

Release 15 of 3 GPP supports multiplexing of 2 or more uplink channels (PUCCH (Physical Uplink Control Channel) and PUSCH (Physical Uplink Shared Channel)) transmitted in the same slot.

In addition, in Release 17 of 3 GPP, it was agreed to support multiplexing on UL SCH (Uplink Shared Channel) having a priority different from that of UCI (Uplink Control Information) (For example, Non-Patent Literature 1).

### CITATION LIST

### Non-Patent Literature

Non-Patent Literature 1 “Enhanced Industrial Internet of Things (IoT) and ultra-reliable and low latency communication”, RP-201310, 3 GPP TSG RAN Meeting #86 e, 3 GPP, July 2020

### SUMMARY OF INVENTION

Against this background, the inventors, as a result of careful examination, found that the multiplexing of UCIs with respect to UL SCH cannot be properly executed if the possible value of the coefficient (For example, beta) used for rate matching remains within the predetermined range.

Accordingly, the following disclosure has been made in view of such a situation, and it is an object of the present invention to provide a terminal capable of appropriately executing multiplexing of uplink control information for an uplink shared channel.

An aspect of the present disclosure is a terminal comprising: a control unit that multiplexes uplink control information on an uplink shared channel; and a communication unit that transmits an uplink signal using the uplink shared channel on which the uplink control information is multiplexed; wherein the control unit multiplies a number of bits constituting the uplink control information by a coefficient in a rate matching of the uplink control information, and the control unit applies, as a range of coefficient, a specific range corresponding to a combination of a priority of the uplink control information and a priority of the uplink shared channel.

### BRIEF DESCRIPTION OF DRAWINGS

FIG. 1 is an overall schematic diagram of a radio communication system 10.

FIG. 2 is a diagram illustrating the frequency range used in radio communication system 10.

FIG. 3 shows an exemplary configuration of a radio frame, subframe, and slot used in a radio communication system 10.

FIG. 4 is a functional block diagram of the UE 200.

FIG. 5 illustrates rate matching.

FIG. 6 illustrates rate matching.

FIG. 7 illustrates rate matching.

FIG. 8 is a diagram showing an example of a range in which the coefficient (β) can be taken.

FIG. 9 shows an example of an information element (ASN.1 format) contained in an RRC message.

FIG. 10 shows an example of an information element (ASN.1 format) contained in an RRC message.

FIG. 11 shows an example of an information element (ASN.1 format) contained in an RRC message.

FIG. 12 shows an exemplary operation of FIG. 12.

FIG. 13 shows an example of an information element (ASN.1 format) contained in an RRC message.

FIG. 14 shows an example of a hardware configuration of the UE 200.

### DESCRIPTION OF EMBODIMENTS

Exemplary embodiments of the present invention are explained below with reference to the accompanying drawings. Note that, the same or similar reference numerals have been attached to the same functions and configurations, and the description thereof is appropriately omitted.

### EMBODIMENTS

### (1) Overall Schematic Configuration of the Radio Communication System

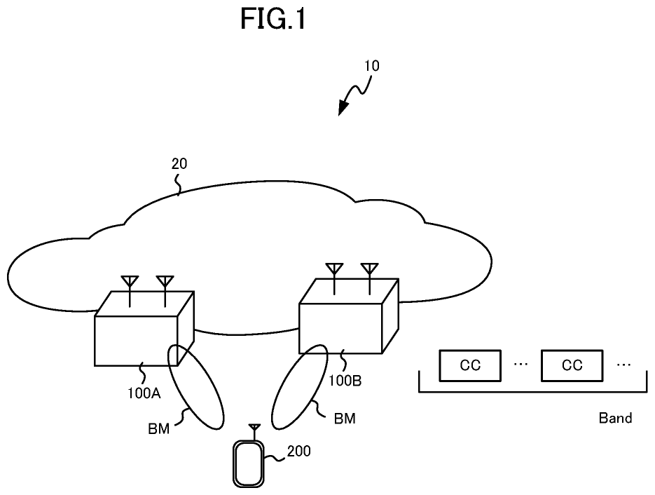

FIG. 1 is an overall schematic configuration diagram of a radio communication system 10 according to an embodiment. radio communication system 10 is a 5G New Radio (NR) compliant radio communication system and includes a Next Generation-Radio Access Network 20 (hereinafter NG-RAN 20), and a terminal 200 (Below, UE 200).

The radio communication system 10 may be a radio communication system that follows a scheme called Beyond 5G, 5G Evolution or 6 G.

The NG-RAN 20 includes a radio base station 100 A (gNB 100 A) and a radio base station 100 B (gNB 100 B). The specific configuration of radio communication system 10 including the number of gNBs and UEs is not limited to the example shown in FIG. 1.

The NG-RAN 20 actually includes a plurality of NG-RAN Nodes, specifically gNBs (or ng-eNBs), and is connected to a core network (5GC, not shown) according to 5G. Note that the NG-RAN 20 and 5 GC may be expressed simply as a “network”.

The gNB 100 A and the gNB 100 B are radio base stations according to 5G, and execute radio communication according to the UE 200 and 5G. By controlling radio signals transmitted from a plurality of antenna elements, the gNB 100 A, the gNB 100 B, and the UE 200 can support Massive MIMO (Multiple-Input Multiple-Output) for generating a beam BM having a higher directivity, carrier aggregation (CA) for bundling a plurality of component carriers (CCs), and dual connectivity (DC) for simultaneously communicating between the UE and each of the two NG-RAN nodes. The DC may include MR-DC (Multi-RAT Dual Connectivity) using MCG (Master Cell Group) and SCG (Secondary Cell Group). Examples of MR-DC include EN-DC (E-UTRA-NR Dual Connectivity), NE-DC (NR-EUTRA Dual Connectivity), and NR-DC (NR-NR Dual Connectivity). Here, CC (cell) used in CA may be considered to constitute the same cell group. MCG and SCG may be considered to constitute the same cell group.

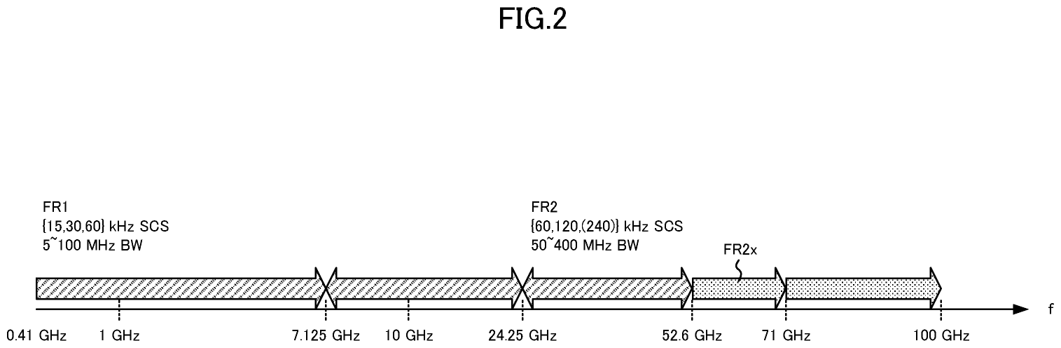

The radio communication system 10 corresponds to a plurality of frequency ranges (FR). FIG. 2 shows the frequency range used in radio communication system 10.

As shown in FIG. 2, the radio communication system 10 corresponds to FR1 and FR2. The frequency bands of each FR are as follows.
FR 1: 410 MHz to 7.125 GHz
FR 2: 24.25 GHz to 52.6 GHz

In FR 1, 15, 30 or 60 kHz Sub-Carrier Spacing (SCS) may be used and a 5˜100 MHz bandwidth (BW) may be used. FR 2 is a higher frequency than FR 1, and an SCS of 60 or 120 kHz (240 kHz may be included) may be used, and a bandwidth (BW) of 50˜400 MHz may be used.

The SCS may be interpreted as numerology. Numerology is defined in 3 GPP TS 38.300 and corresponds to one subcarrier interval in the frequency domain.

Furthermore, the radio communication system 10 also supports a higher frequency band than the FR 2 frequency band. Specifically, the radio communication system 10 supports the frequency band above 52.6 GHz up to 114.25 GHz. Such a high frequency band may be referred to as “FR2x” for convenience.

In order to solve the problem that the influence of phase noise becomes large in the high frequency band, cyclic prefix-orthogonal frequency division multiplexing (CP-OFDM)/cliscrete Fourier transform-spread (DFT-S-OFDM) with larger sub-carrier spacing (SCS) may be applied when using the band above 52.6 GHz.

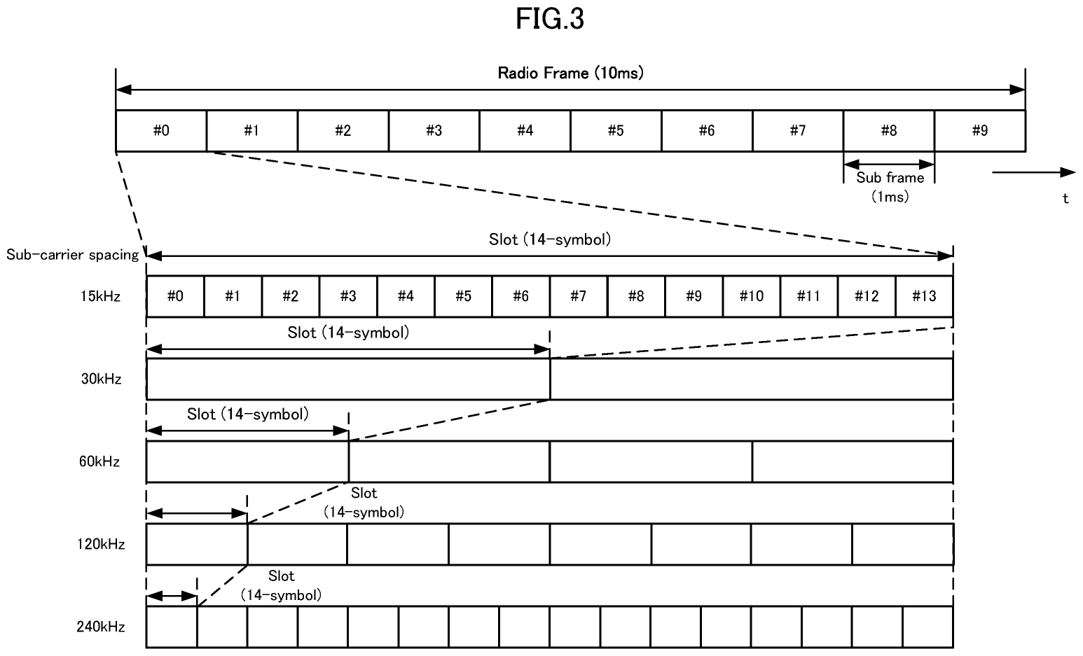

FIG. 3 shows a configuration example of a radio frame, a sub-frame and a slot used in radio communication system 10.

As shown in FIG. 3, one slot comprises 14 symbols, and the larger (wider) the SCS, the shorter the symbol period (and the slot period). The SCS is not limited to the spacing (frequency) shown in FIG. 3. For example, 480 kHz, 960 kHz, and the like may be used.

The number of symbols constituting 1 slot is not necessarily 14 (For example, 28, 56 symbols). Furthermore, the number of slots per subframe may vary depending on the SCS.

The time direction (t) shown in FIG. 3 may be referred to as a time region, a symbol period or a symbol time. The frequency direction may be referred to as a frequency domain, a resource block, a subcarrier, a BWP (Bandwidth Part), or the like.

### (2) Function Block Configuration of Radio Communication System

Next, the functional block configuration of radio communication system 10 will be described. Specifically, the functional block configuration of the UE 200 will be described.

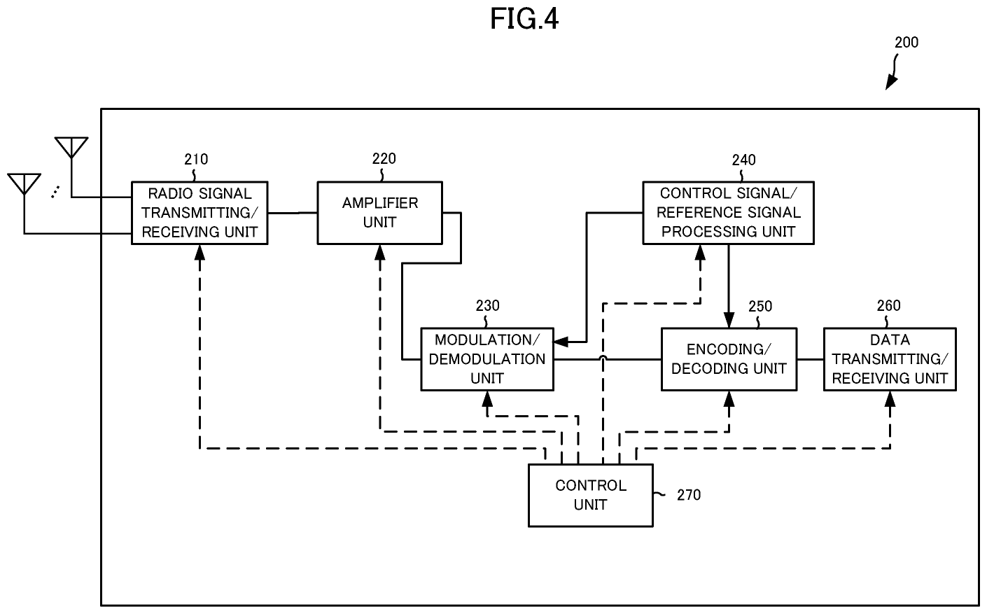

FIG. 4 is a functional block diagram of the UE 200. As shown in FIG. 4, the UE 200 includes a radio signal transmission/reception unit 210, an amplifier unit 220, a modulation/demodulation unit 230, a control signal/reference signal processing unit 240, an encoding/decoding unit 250, a data transmission/reception unit 260 and a control unit 270.

The radio signal transmission/reception unit 210 transmits and receives radio signals in accordance with NR. The radio signal transmission/reception unit 210 supports Massive MIMO, CA with multiple CCs bundled together, and DC with simultaneous communication between the UE and each of the two NG-RAN Nodes.

The amplifier unit 220 is composed of a PA (Power Amplifier)/LNA (Low Noise Amplifier) and the like. The amplifier unit 220 amplifies the signal output from modulation/demodulation unit 230 to a predetermined power level. The amplifier unit 220 also amplifies the RF signal output from radio signal transmission/reception unit 210.

The modulation/demodulation unit 230 performs data modulation/demodulation, transmission power setting, resource block allocation and the like for each predetermined communication destination (gNB 100 or other gNB). In the modulation/demodulation unit 230, Cyclic Prefix-Orthogonal Frequency Division Multiplexing (CP-OFDM)/Discrete Fourier Transform-Spread (DFT-S-OFDM) may be applied. The DFT-S-OFDM may be used not only in the uplink (UL) but also in the downlink (DL).

The control signal/reference signal processing unit 240 executes processing relating to various control signals transmitted and received by the UE 200 and processing relating to various reference signals transmitted and received by the UE 200.

Specifically, the control signal/reference signal processing unit 240 receives various control signals transmitted from the gNB 100 via a predetermined control channel, for example, a control signal of the radio resource control layer (RRC). The control signal/reference signal processing unit 240 transmits various control signals to the gNB 100 through a predetermined control channel.

The control signal/reference signal processing unit 240 performs processing using reference signals (RS) such as the Demodulation Reference Signal (DMRS) and the Phase Tracking Reference Signal (PTRS).

The DMRS is a reference signal (pilot signal) known between a base station and a terminal of each terminal for estimating a fading channel used for data demodulation. The PTRS is a reference signal for each terminal for the purpose of estimating phase noise which becomes a problem in a high frequency band.

In addition to DMRS and PTRS, the reference signal may include a Channel State Information-Reference Signal (CSI-RS), a Sounding Reference Signal (SRS), and a Positioning Reference Signal (PRS) for position information.

The channel includes a control channel and a data channel. The control channel includes PDCCH (Physical Downlink Control Channel), PUCCH (Physical Uplink Control Channel), RACH (Random Access Channel), Downlink Control Information (DCI) including a Random Access Radio Network Temporary Identifier (RA-RNTI), and a Physical Broadcast Channel (PBCH).

The data channels include PDSCH (Physical Downlink Shared Channel) and PUSCH (Physical Uplink Shared Channel). Data means data transmitted over a data channel. The data channel may be read as a shared channel.

In the embodiment, the control signal/reference signal processing unit 240 constitutes a communication unit that transmits an uplink signal by using an uplink shared channel (UL SCH) in which uplink control information (UCI (Uplink Control Information)) is multiplexed. UL SCH is a transport channel multiplexed with PUSCH: Physical Uplink Shared Channel. Uplink signals transmitted over UL SCH (PUSCH) may include UCIs and may include data. The UCI may include an acknowledgment (HARQ-ACK) for one or more TBs. The UCI may include a Scheduling Request (SR) requesting the scheduling of a resource and may include a Channel State Information (CSI) representing the state of the channel. The UCI may be transmitted via PUCCH or via PUSCH.

The encoding/decoding unit 250 executes data division/connection, channel coding/decoding and the like for each predetermined communication destination (gNB 100 or other gNB).

Specifically, the encoding/decoding unit 250 divides the data output from data transmission/reception unit 260 into predetermined sizes, and executes channel coding on the divided data. The encoding/decoding unit 250 decodes the data output from modulation/demodulation unit 230 and connects the decoded data.

The data transmission/reception unit 260 sends and receives protocol data units (PDU) and service data units (SDU). Specifically, the data transmission/reception unit 260 performs assembly/disassembly of PDUs/SDUs in a plurality of layers (Media access control layer (MAC), radio link control layer (RLC), and packet data convergence protocol layer (PDCP), etc.). data transmission/reception unit 260 executes error correction and retransmission control of the data based on the hybrid automatic repeat request (HARQ).

The control unit 270 controls each functional block constituting the UE 200. In particular, in embodiments, the control unit 270 comprises a control unit that multiplexes the UCI with the UL SCH. control unit 270 multiplies the number of bits constituting the UCI by a coefficient (β) in the rate matching of the UCI. The control unit 270 applies a range of coefficients (β) that corresponds to a combination of UCI priorities and UL SCH priorities. The default range may be considered to be the range defined in Release 16 of 3 GPP. The specific range may be considered to be the range defined in Release 17 of 3 GPP.

### (3) Rate Matching

Rate matching will be described below. Specifically, the rate matching of the UCI in the case of multiplexing the UCI with the UL SCH will be described. Here, HARQ-ACK, CSI Part 1, and CSI Part 2 are exemplified as UCIs. Note that HARQ-ACK, CSI-Part1 and CSI-Part2 are executed separately.

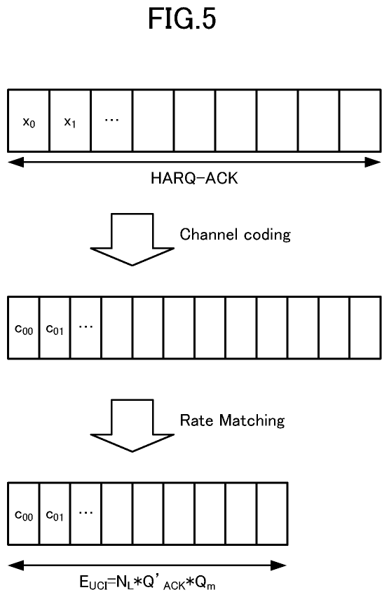

As shown in FIG. 5, channel coding is applied to HARQ-ACK having bit sequences of “X₀,” X₁, and “. . . ” to obtain bit sequences “C00, C01, and . . . ”. Rate matching is applied to such bit sequences. The bit sequence after rate matching (E_{UCI}) may be represented by E_{UCI}=N_{L}×Q′_{ACK}×Qₘ.

N_{L} is the number of transmission layers of the PUSCH. Qₘ is a modulation condition of PUSCH. For example, Q′_{ACK} is expressed by the following formula (TS 38.212 V 16.3.0 § 6.3.2.4.1.1 “HARQ-ACK”).

$${Q}_{ACK}^{′} = min \{ ⌈ \frac{( {O}_{A C K} + {L}_{A C K} ) \cdot {β}_{offset}^{PUSCH} \cdot {\sum }_{l = 0}^{{N}_{symb , all}^{P U S C H} - 1} {M}_{s c}^{UCI} ( l )}{{\sum }_{r = 0}^{{C}_{U L - S C H} - 1} {K}_{r}} ⌉ , \\ ⌈ α \cdot {\sum }_{l = 0}^{{N}_{s y m b , a l {l}^{- 1}}^{P U S C H}} {M}_{s c}^{UCI} ( l ) ⌉ \} \qquad [ Equation 1 ]$$

O_{ACK} is the number of bits of HARQ-ACK.

L_{ACK} is the number of bits of CRC applied for HARQ-ACK.

β_{offset}^{PUSCH} is β_{offset}^{HARQ-ACK}, and β_{offset}^{HARQ-ACK} is an example of the coefficient (β) multiplied to the number of bits constituting HARQ-ACK.

M_{sc}^{UCI}(l) is a bandwidth scheduled for PUSCH transmission, and is expressed by the number of subcarriers.

C_{UL-SCH} is the number of code blocks for UL-SCH of PUSCH transmission.

α is an example of the scaling factor multiplied to the radio resource (here, M_{sc}^{UCI}(l)) which can be used for the transmission of UCI.

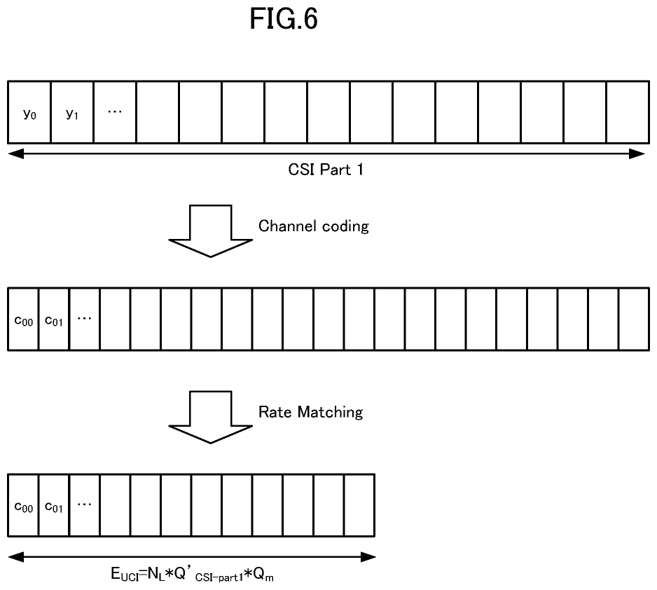

As shown in FIG. 6, channel coding is applied to CSI Part 1 having bit sequences of “Y₀, Y₁, and . . . ” to obtain bit sequences of “C00, C01, and . . . ”. Rate matching is applied to such bit sequences. The bit sequence after rate matching (E_{UCI}) may be represented by E_{UCI}=N_{L}×Q′_{CSI-part1}×Qₘ.

N_{L} is the number of transmission layers of the PUSCH. Qₘ is a modulation condition of PUSCH. For example, Q′_{CSI-part1} is expressed by the following formula (TS 38.212 V 16.3.0 § 6.3.2.4.1.2 “CSI part 1”).

$${Q}_{CSI - 1}^{′} = min \{ \begin{matrix}⌈ \frac{( {O}_{CSI - 1} + {L}_{CSI - 1} ) \cdot {β}_{offset}^{PUSCH} \cdot {\sum }_{l = 0}^{{N}_{symb , all}^{P U S C H} - 1} {M}_{s c}^{UCI} ( l )}{{\sum }_{r = 0}^{{C}_{U L - S C H} - 1} {K}_{r}} ⌉ , \\ ⌈ α \cdot {\sum }_{l = 0}^{{N}_{s y m b , a l {l}^{- 1}}^{P U S C H}} {M}_{s c}^{UCI} ( l ) ⌉ - {Q}_{ACK / CGI - UCI}^{′}\end{matrix} \} \qquad [ Equation 2 ]$$

O_{CSI-1} is the number of bits of CSI Part 1.

L_{CSI-1} is the number of bits of CRC applied for CSI Part 1.

β_{offset}^{PUSCH} is β_{OFFSET}^{CSI-part1}, and β_{offset}^{CSI-part1} is an example of the coefficient (β) multiplied to the number of bits constituting CSI Part 1.

M_{sc}^{UCI}(l) is a bandwidth scheduled for PUSCH transmission, and is expressed by the number of subcarriers.

C_{UL-SCH} is the number of code blocks for UL-SCH of PUSCH transmission.

α is an example of the scaling factor multiplied to the radio resource (here, M_{sc}^{UCI}(l)) which can be used for the transmission of UCI.

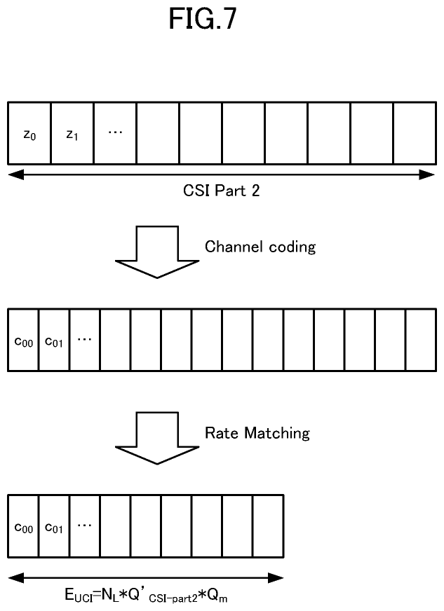

As shown in FIG. 7, channel coding is applied to the CSI Part 2 having the bit sequences of Z₀, Z₁, and . . . ” to obtain the bit sequences of “C00, C01, and . . . ”. Rate matching is applied to such bit sequences. The bit sequence after rate matching (E_{UCI}) may be represented by E_{UCI}=N_{L×}×Q′_{CSI-part2}×Qₘ.

N_{L} is the number of transmission layers of the PUSCH. Qₘ is a modulation condition of PUSCH. For example, Q′_{CSI-part2} is expressed by the following formula (TS 38.212 V 16.3.0 § 6.3.2.4.1.3 “CSI part 2”).

$${Q}_{CSI - 2}^{′} = min \{ \begin{matrix}⌈ \frac{( {O}_{CSI - 2} + {L}_{CSI - 2} ) \cdot {β}_{offset}^{PUSCH} \cdot {\sum }_{l = 0}^{{N}_{symb , all}^{P U S C H} - 1} {M}_{s c}^{UCI} ( l )}{{\sum }_{r = 0}^{{C}_{U L - S C H} - 1} {K}_{r}} ⌉ , \\ ⌈ α \cdot {\sum }_{l = 0}^{{N}_{s y m b , a l {l}^{- 1}}^{P U S C H}} {M}_{s c}^{UCI} ( l ) ⌉ - {Q}_{ACK / CGI - UCI}^{′} - {Q}_{CSI - 1}^{′}\end{matrix} \} \qquad [ Equation 3 ]$$

O_{CSI-2} is the number of bits of CSI Part 2.

L_{CSI-2} is the number of bits of CRC applied for CSI Part 2.

β_{offset}^{PUSCH} is β_{offset}^{CSI-part2}, and β_{offset}^{CSI-part2} is an example of the coefficient (β) multiplied to the number of bits constituting CSI Part 2.

M_{sc}^{UCI}(l) is a bandwidth scheduled for PUSCH transmission, and is expressed by the number of subcarriers.

C_{UL-SCH} is the number of code blocks for UL-SCH of PUSCH transmission.

α is an example of the scaling factor multiplied to the radio resource (here, M_{sc}^{UCI}(l)) which can be used for the transmission of UCI.

### (4) Possible Range of Coefficients (β)

The possible range of the coefficient (β) will be described below. Here, a coefficient (β) applied to HARQ-ACK will be described by way of example.

### (4.1) Default Range

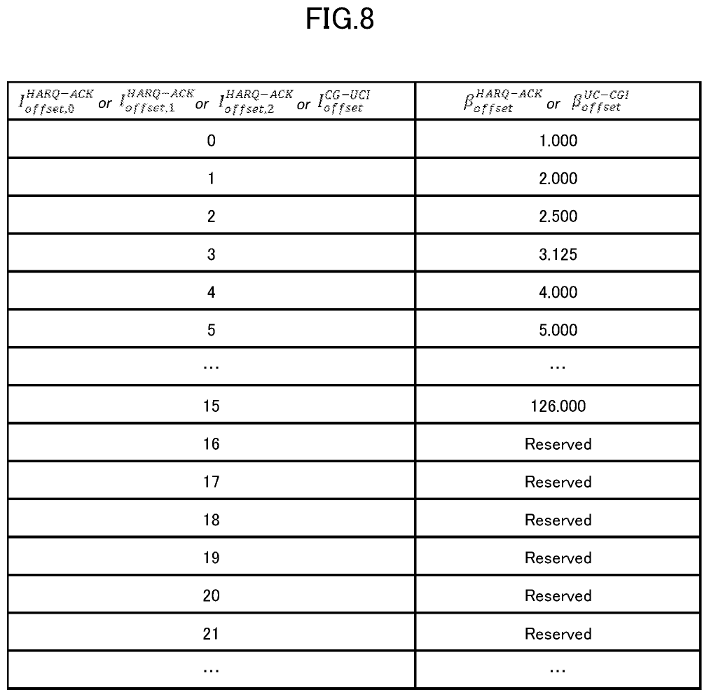

As shown in FIG. 8, for the default range, the coefficient (β) shown in the right column is associated with the index shown in the left column (TS 38.213 V 16.3.0 § 9.3 “UCI reporting in physical uplink shared channel”). For example, the minimum possible value of the coefficient (β) in the predetermined range is “1.000”, and the maximum possible value of the coefficient (β) in the predetermined range is “126.000”. Indexes of 16 and above do not have a coefficient (β) associated with them and can be used for future expansion (Reserved). As noted above, the default range is the range defined in 3 GPP Release 16.

### (4.2) Specified Scope

As described above, the specific range is defined according to a combination of the UCI priority and the UL SCH priority. Here, HARQ-ACK is exemplified as the UCI. The UCI may be CSI Part 1, CSI Part 2, or SR.

The combination of the UCI priority and the UL SCH (In this case, PUSCH) priority may include (i) a combination of LP (Low Priority) HARQ-ACK and LP PUSCH, (ii) a combination of LP HARQ-ACK and HP (High Priority) PUSCH, (iii) a combination of HP HARQ-ACK and LP PUSCH, and (iv) a combination of HP HARQ-ACK and LP PUSCH.

(i) The index associated with the specific range according to the combination of LP (Low Priority) HARQ-ACK and LP PUSCH may be referred to as betaOffsetACK-Index1. (ii) The index associated with a specific range according to the combination of LP HARQ-ACK and HP (High Priority) PUSCH may be referred to as betaOffsetACK-Index2. (iii) The index associated with a specific range according to the combination of HP HARQ-ACK and LP PUSCH may be referred to as betaOffsetACK-Index 3. (iv) The index associated with a specific range according to the combination of HP HARQ-ACK and LP PUSCH may be referred to as betaOffsetACK-Index 4.

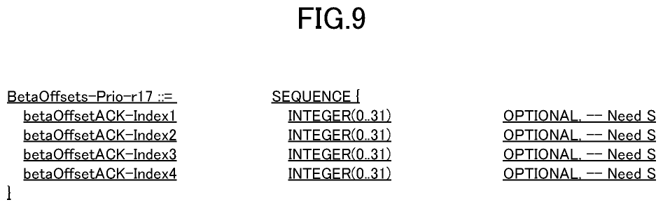

The setting configuration shown in FIG. 9 may be employed as the setting configuration of a specific range (betaOffsetACK-Index 1 through betaOffsetACK-Index 4) corresponding to the combination of the UCI priority and the UL SCH priority.

Specific ranges corresponding to combinations of HARQ-ACK and PUSCH having the same priority may be excluded. In other words, the specified range shown in FIG. 8 may be used as the range of coefficients (β) corresponding to the combination of HARQ-ACK and PUSCH having the same priority.

### (5) Example of Applying Extended Range

An application example of the extended range will be described below. Here, the conditions required in the case of applying the extended range will be described.

### (5.1) Condition 1

Condition 1 is specified based on a radio resource control message (RRC message). In other words, UE 200 applies the extended range based on the RRC message.

Condition 1 is specified based on a radio resource control message (RRC message). In other words, UE 200 applies a specific range based on the RRC message.

For example, the RRC message may include an information element that indicates whether or not a particular range applies. A range may be applied if the RRC message contains an information element indicating that the range is applied. The specific range may not be applied if the RRC message does not include an information element indicating that the specific range applies, or if the RRC message includes an information element indicating that the specific range does not apply.

### (5.1.1) Example 1

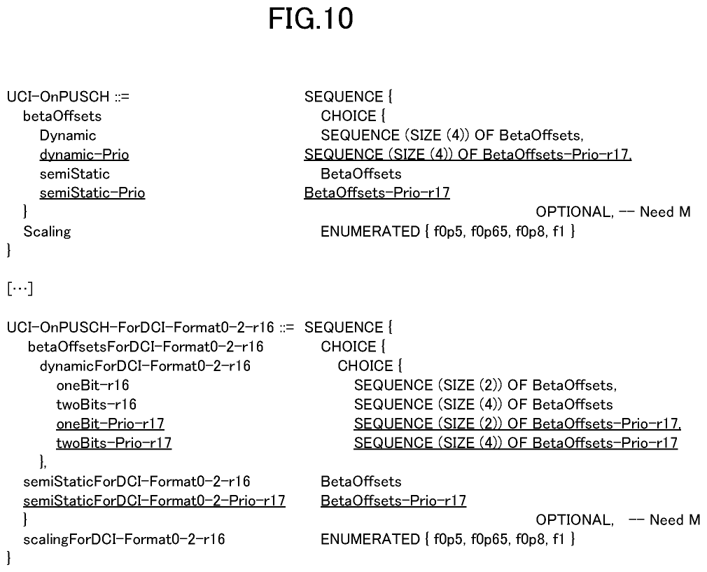

As shown in FIG. 10, UCI-OnPUSCH may include Dynamic or semiStatic as betaOffsets specifying the coefficient (β). UCI-OnPUSCH may include Dynamic-Prio or semiStatic-Prio as betaOffsets that specify coefficients (β) included in a specific range. UCI-OnPUSCH-ForDCI-Fromat 0-2-r16 is an information element used when the format of the DCI is DCI Format 0_2. UCI-OnPUSCH-ForDCI-Fromat 0-2-r16 may include DynamicForDCI-Fromat 0-2-r16 or semiStaticForDCI-Fromat 0-2-r16 as betaOffsets specifying coefficients (β). UCI-OnPUSCH-ForDCI-Fromat 0-2-r16 may include oneBit-prio-r17 or twoBit-prio-r17 included in DynamicForDCI-Fromat 0-2-r16 or may include semiStaticForDCI-Fromat 0-2-Prio-r17 as betaOffsets specifying coefficients (β) included in a specific range.

### (5.1.2) Example 2

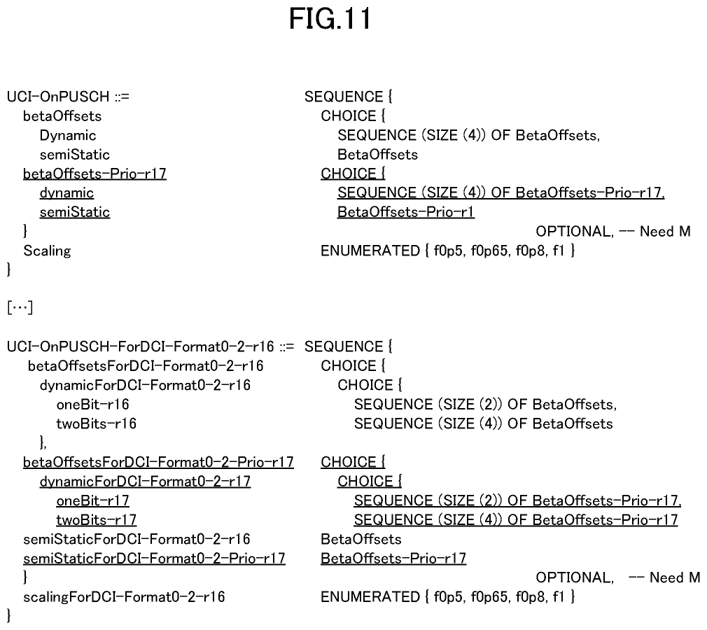

As shown in FIG. 11, UCI-OnPUSCH may include Dynamic or semiStatic as betaOffsets specifying the coefficient (β). UCI-OnPUSCH includes betaOffsets-Prio-r17 which specifies the coefficients (β) included in the specified range. betaOffsets-Prio-r17 may include Dynamic or semiStatic. UCI-OnPUSCH-ForDCI-Fromat 0-2-r16 is an information element used when the format of the DCI is DCI Format 0_2. UCI-OnPUSCH-ForDCI-Fromat 0-2-r16 may include DynamicForDCI-Fromat 0-2-r16 or semiStaticForDCI-Fromat 0-2-r16 as betaOffsets specifying coefficients (β). UCI-OnPUSCH-ForDCI-Fromat 0-2-r16 may include UCI-OnPUSCH-ForDCI-Fromat 0-2-Prio-r17 as an information element for specifying a coefficient (β) included in a specific range. UCI-OnPUSCH-ForDCI-Fromat 0-2-Prio-r17 may include DynamicForDCI-Fromat 0-2-Prio-r17 or semiStaticForDCI-Fromat 0-2-Prio-r17 as betaOffsets specifying coefficients (β) included in a particular range. DynamicForDCI-Fromat 0-2-Prio-r17 may include oneBit-prio-r17 or twoBit-prio-r17.

### (5.2) Condition 2

Condition 2 is that a UE Capability including an information element for a specific range of application has been reported from UE 200. In other words, the UE 200 applies a specific range based on the UE Capability of the UE 200.

For example, the information element for applying a specific range may be an information element indicating that the UE 200 supports UCI multiplexing for uplink channels (UL-SCH, PUSCH) of a different priority from that of the UCI. The information element relating to the application of the specific range may be an information element indicating that the UE 200 corresponds to the specific range.

### (5.3) Condition 3

Condition 3 is that the format of the downlink control information (DCI) is a specific format. In other words, UE 200 applies a specific range based on the DCI. The specific format may be DCI Format 0_2.

The condition 3 may be combined with the above-mentioned condition 1. For example, if the betaOffset-Table-r17 included in the UCI-OnPUSCH-ForDCI-Fromat 0-2-r16 is enabled and the format of the DCI is DCI Format 0_2, a specific range may be applied. Alternatively, a range may be applied if UCI-OnPUSCH-ForDCI-Fromat 0-2-r16-r17 is included in the RRC message and the format of the DCI is DCI Format 0_2.

### (5.4) Condition 4

The condition 4 may be that the priority of the uplink control information (UCI) is different from that of the uplink shared channel (UL-SCH, PUSCH). In other words, UE 200 may apply a specific range if the UCI priority is different from the UL-SCH priority.

For example, if the UCI has a low priority and the UL-SCH has a high priority, a specific range may be applied that includes values less than the default range. In such a case, a UCI having a high priority may already be multiplexed on the PUSCH (UL-SCH). If the UCI has a high priority and the UL-SCH has a low priority, a specific range may be applied that includes values greater than the default range.

Note that the UE 200 may apply the default range when the priority of the UCI is the same as the priority of the UL-SCH. However, the UE 200 may apply a specific range when the priority of the UCI is the same as the priority of the UL-SCH. Cases in which the priority of a UCI is the same as the priority of UL-SCH may include cases in which the priority of both UCI and UL-SCH is low, and may include cases in which the priority of both UCI and UL-SCH is high.

### (6) Operation Example

An operation example of the embodiment will be described below. The multiplexing of UCI over UL-SCH (PUSCH) is mainly described below.

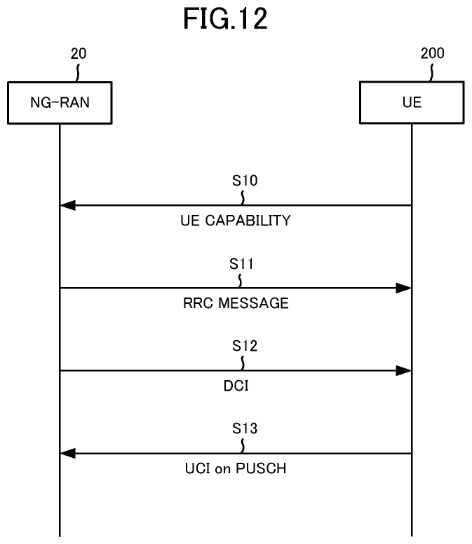

As shown in FIG. 12, in step 10, the UE 200 transmits a message containing UE Capability to the NG-RAN 20. The UE Capability may include information elements for a specific range of applications (condition 2 above).

In step 11, the UE 100 receives an RRC message from the NG-RAN 20. The RRC message may include an information element indicating whether or not a particular range is to be applied (condition 1 described above).

In step 12, the UE 200 receives 1 or more DCIs from the NG-RAN 20 via the PDCCH. The format of the DCI may be DCI Format 0-2 (condition 4 described above).

In step 13, the UE 200 transmits an uplink signal using the UL-SCH (PUSCH) multiplexed with the UCI. In such a case, the UE 200 may apply a specific range as a possible range of the coefficient (β) based on at least one of the conditions 1 to 4 described above.

### (7) Operational Effects

In the embodiment, the UE 200 applies a specific range according to a combination of the priority of the UCI and the priority of the UL SCH as a possible range of the coefficient (β) used in the rate matching. According to this configuration, multiplexing of the uplink control information (UCI) with respect to the uplink shared channel (UL-SCH, PUSCH) can be appropriately executed. In particular, such a configuration is useful in cases where the priority of the UCI is different from the priority of the UL-SCH.

### Example 1

A first modification of the embodiment will be described below. Hereinafter, the difference with respect to the embodiment will be described.

In embodiments, the specific range is a range that corresponds to a combination of the UCI priority and the UL SCH priority. On the other hand, in Modification 1, the specific range may be a range corresponding to the combination of the priority of UCI and the priority of UL SCH and the number of bits of UCI. Here, HARQ-ACK is exemplified as the UCI. The UCI may be CSI Part 1, CSI Part 2, or SR.

For example, the combination of the UCI priority with the UL SCH (In this case, PUSCH) priority and the number of UCI bits may include (i) a combination of LP HARQ-ACK and LP PUSCH of a number of bits less than or equal to the threshold N1, (ii) a combination of LP HARQ-ACK and LP PUSCH of a number of bits greater than the threshold Ni and less than or equal to the threshold N2 (>N1), and (iii) a combination of LP HARQ -ACK and LP PUSCH of a number of bits greater than the threshold N2. (i) The index associated with the specific range according to the combination of LP HARQ-ACK and LP PUSCH having the number of bits less than or equal to the threshold N1 may be referred to as betaOffsetACK-Index1. (ii) An index associated with a specific range according to a combination of LP HARQ-ACK and LP PUSCH having a number of bits greater than the threshold Ni and less than or equal to the threshold N2 (>N1) may be referred to as betaOffsetACK-Index2. (iii) An index associated with a specific range according to a combination of LP HARQ-ACK and LP PUSCH having a number of bits greater than the threshold value N2 may be referred to as betaOffsetACK-Index3.

The combination of the UCI priority and the PUSCH priority and the number of bits of the UCI may include (iv) a combination of LP HARQ-ACK and HP PUSCH of a number of bits less than or equal to the threshold N3, (v) a combination of LP HARQ-ACK and HP PUSCH of a number of bits greater than the threshold N3 and less than or equal to the threshold N4 (>N3), and (vi) a combination of LP HARQ-ACK and HP PUSCH of a number of bits greater than the threshold N4. (iv) The index associated with the specific range according to the combination of LP HARQ-ACK and HP PUSCH having the number of bits less than or equal to the threshold N3 may be referred to as betaOffsetACK-Index 4. (v) An index associated with a specific range according to a combination of LP HARQ-ACK and HP PUSCH having a number of bits greater than the threshold N3 and less than or equal to the threshold N4 (>N3) may be referred to as betaOffsetACK-Index 5. (vi) An index associated with a specific range according to a combination of LP HARQ-ACK and HP PUSCH having a number of bits greater than the threshold N4 may be referred to as betaOffsetACK-Index 6.

The combination of the UCI priority and the PUSCH priority and the number of bits of the UCI may include (vii) a combination of HP HARQ-ACK and LP PUSCH of a number of bits less than or equal to the threshold N5, (viii) a combination of HP HARQ-ACK and LP PUSCH of a number of bits greater than the threshold N5 and less than or equal to the threshold N6 (>N5), and (ix) a combination of HP HARQ-ACK and LP PUSCH of a number of bits greater than the threshold N6. (vii) An index associated with a specific range according to a combination of HP HARQ-ACK and LP PUSCH having a number of bits less than or equal to the threshold N5 may be referred to as betaOffsetACK-Index 7. (viii) An index associated with a specific range according to a combination of HP HARQ-ACK and LP PUSCH having a number of bits greater than the threshold N5 and less than or equal to the threshold N6 (>N5) may be referred to as betaOffsetACK-Index8. (ix) An index associated with a specific range according to a combination of HP HARQ-ACK and LP PUSCH having a number of bits greater than the threshold N6 may be referred to as betaOffsetACK-Index 9.

The combination of the UCI priority and the PUSCH priority and the number of bits of the UCI may include (x) a combination of HP HARQ-ACK and HP PUSCH of a number of bits less than or equal to the threshold N7, (xi) a combination of HP HARQ-ACK and HP PUSCH of a number of bits greater than the threshold N7 and less than or equal to the threshold N8 (>N7), and (xii) a combination of HP HARQ-ACK and HP PUSCH of a number of bits greater than the threshold N8. (x) An index associated with a specific range according to a combination of HP HARQ-ACK and HP PUSCH having a number of bits less than or equal to the threshold N7 may be referred to as betaOffsetACK-Index 10. (xi) An index associated with a specific range according to a combination of HP HARQ-ACK and HP PUSCH having a number of bits greater than the threshold N7 and less than or equal to the threshold N8 (>N7) may be referred to as a betaOffsetACK-Index 11. (xii) An index associated with a specific range according to a combination of HP HARQ-ACK and HP PUSCH having a number of bits greater than the threshold N8 may be referred to as betaOffsetACK-Index 12.

Specific ranges corresponding to combinations of HARQ-ACK and PUSCH having the same priority may be excluded. In other words, the specified range shown in FIG. 8 may be used as the range of coefficients (β) corresponding to the combination of HARQ-ACK and PUSCH having the same priority.

A specific range corresponding to a combination selected from the combinations (i) to (xii) described above may be excluded. For example, (v) a specific range corresponding to a combination of LP HARQ-ACK and HP PUSCH having a number of bits larger than the threshold N3 and equal to or smaller than the threshold N4 (>N3) may be excluded.

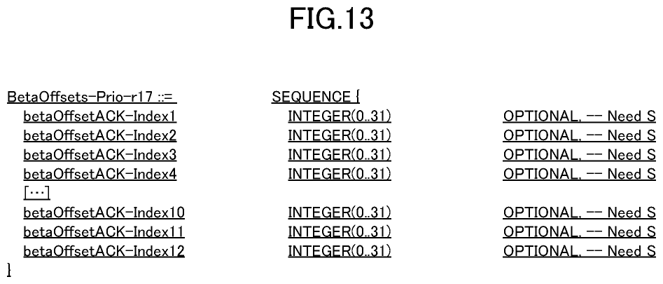

The setting configuration shown in FIG. 13 may be employed as the setting configuration of a specific range (betaOffsetACK-Index 1 through betaOffsetACK-Index 12) according to the combination of the UCI priority and the UL SCH priority.

The RRC message may be an RRC message shown in FIG. 10 or an RRC message shown in FIG. 11.

### Example 2

A second modification of the embodiment will be described below. Hereinafter, differences with respect to the embodiments will be mainly described.

The specific range may be applied based on one or more information elements selected from the RRC message, UE Capability and DCI. For example, in a case where UCI and UL SCH with different priorities are supported (For example, UCI and UL SCH with different priorities are activated) based on one or more information elements selected from the RRC message UE Capability and DCI, a new coefficient (β) may be applied instead of the existing coefficient (β) if the DCI format includes a beta offset indicator of one or two bits. For example, the new coefficient (β) may be BetaOffsetsPrio-r17.

Specific ranges may be applied based on newly defined DCI fields. The newly defined DCI field may be a field that stores an information element that identifies whether the beta_offset indicator indicates a new coefficient (beta) or an existing coefficient (beta). The newly defined DCI field may be used when certain RRC parameters are set. For example, a newly defined DCI field may be used when the newly introduced betaOffsetForPrio is set. The size of the newly defined DCI field may be 1 bit. If the newly defined DCI field is set to “1”, a new coefficient (β) may be applied. When the DCI format is a specific format (DCI_Format_0_1 or DCI_Format_0_2), a newly defined DCI field may be used.

Specific ranges may be applied on the basis of the RNTI. For example, if the DCI format includes a beta offset indicator of one or two bits, and the DCI is scrambled by a specific RNTI (For example, MCS-C-RNTI), a new coefficient (β) may be applied instead of the existing coefficient (β). For example, the new coefficient (β) may be BetaOffsetsPrio-r17.

### Change Example 3

A third modification of the embodiment will be described below. Hereinafter, differences with respect to the embodiments will be mainly described.

In the modification example 3, a case where four or more specific ranges are introduced in order to multiplex one type of UCI to PUSCH will be described. The specific range corresponds to the bit size of the UCI.

For example, for a specific range (beta-offsets) M₁ (M₁≥1) for multiplexing HP HARQ-ACK to HP PUSCH, the following may be applied.

If M₁ is 1, betaOffsetACK-Index-1 is applied when HP HARQ-ACK is multiplexed to PUSCH regardless of the number of bits of HP HARQ-ACK. If M₁ is greater than 1, betaOffsetACK-Index-1 is applied when HP HARQ-ACK of bit number N₁ or less is multiplexed to PUSCH, betaOffsetACK-Index-m is applied when HP HARQ-ACK of bit number _{Nm} (1<m<M₁) or less greater than Nₘ₋₁ (1<m<M₁) is multiplexed to PUSCH, and betaOffsetACK-Index-M₁ may be applied when HP HARQ-ACK of Nₘ₋₁ or more is multiplexed to PUSCH.

For example, for a specific range (beta-offsets) M₂ (M₂≥1) for multiplexing HP HARQ-ACK to HP PUSCH, the following may be applied.

When M₂ is 1, betaOffsetACK-Index-(M₁+1) is applied when HP HARQ-ACK is multiplexed to PUSCH regardless of the number of bits of HP HARQ-ACK. When M₂ is greater than 1, betaOffsetACK-Index-(M₁+1) is applied when HP HARQ-ACK of N_{(M_1+1)} or less bits is multiplexed to PUSCH, and betaOffsetACK-Index-m is applied when HP HARQ-ACK of Nₘ (M₁+1<m<M₁+M₂) or less bits is multiplexed to PUSCH larger than Nₘ₋₁ (M₁+1<m<M₁+M₂), and betaOffsetACK-Index-m is applied when HP HARQ-ACK of N_{(M_1+M_2)} or more bits is multiplexed to PUSCH, betaOffsetACK-Index-(M₁+M₂) may be applied.

For example, for a specific range (beta-offsets) M₃ (M₃≥1) for multiplexing HP HARQ-ACK to HP PUSCH, the following may be applied.

When M₃ is 1, betaOffsetACK-Index-(M₁+M₂+1) is applied when HP HARQ-ACK is multiplexed to PUSCH regardless of the number of bits of HP HARQ-ACK. When M₃ is greater than 1, betaOffsetACK-Index-(M₁+M₂+1) is applied when HP HARQ-ACK of bit number less than or equal to N_{(M_1+M_2+1}) is multiplexed to PUSCH, and betaOffsetACK-Index-m is applied when HP HARQ-ACK of bit number less than or equal to Nₘ (M₁+M₂+1<m<M₁+M₂+M₃) is multiplexed to PUSCH, which is greater than or equal to Nₘ₋₁ (M₁+M₂+1<m<M₁+M₂+M₃), When HP HARQ-ACK larger than N_{(M_1+M_2+M_3)} is multiplexed to PUSCH, betaOffsetACK-Index-(M₁+M₂+M₃) may be applied.

For example, for a specific range (beta-offsets) M₄ (M₄≥1) for multiplexing HP HARQ-ACK to HP PUSCH, the following may be applied.

When M₄ is 1, betaOffsetACK-Index-(M₁+M₂+M₃+1) is applied when HP HARQ-ACK is multiplexed to PUSCH regardless of the number of bits of HP HARQ-ACK. When M₄ is greater than 1, betaOffsetACK-Index-(M₁+M₂+M₃+1) is applied when HP HARQ-ACK of bit number less than or equal to N_{(M_1+M_2+M_3+1)} is multiplexed to PUSCH, and betaOffsetACK-Index-(M₁+M₂+M₃+1<m<M₁+M₂+M₃+M₄) is applied when HP HARQ-ACK of bit number less than or equal to Nₘ₋₁ (M₁+M₂+M₃+1<M₁+M₂+M₃+M₄) is multiplexed to PUSCH, If betaOffsetACK-Index-m is applied and HP HARQ-ACK greater than N_{(M_1+M_2+M_3+M_4)} is multiplexed to PUSCH, betaOffsetACK-Index-(M₁+M₂+M₃+M₄) may be applied.

Note that “M₁≥1”, “M₂≥1”, “M₃≥1”, and “M₄≥1” may be predetermined or determined by gNB. “Nₘ” and “M₁+M₂+M₃+M₄” may be predetermined or determined by gNB.

### Other Embodiments

Although the contents of the present invention have been described in accordance with the embodiments described above, it is obvious to those skilled in the art that the present invention is not limited to these descriptions and that various modifications and improvements are possible.

In the above disclosure, HARQ-ACK is mainly described. However, the foregoing disclosure is not limited thereto. The UCI multiplexed on the UL-SCH may include CSI Part 1 or CSI Part 2. In such a case, the specific range may be a range corresponding to the combination of the priority of the UCI and the priority of the PUSCH and the type of the UCI.

Although not specifically mentioned in the above disclosure, the priority may be determined as follows. For example, the priority of HARQ-ACK may be higher than the priority of SR. The priority for URLLC (Ultra Reliable and Low Latency Communications) may be higher than the priority for eMBB (enhanced Mobile Broadband).

The block configuration diagram (FIG. 4) used in the description of the above-described embodiment shows blocks in units of functions. Those functional blocks (structural components) can be realized by a desired combination of at least one of hardware and software. Means for realizing each functional block is not particularly limited. That is, each functional block may be implemented using a physically or logically coupled device, or may be implemented using two or more physically or logically separated devices connected directly or indirectly (For example, by using wired, wireless, etc.). The functional block may be implemented by combining software with the one device or the plurality of devices.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmission is called a transmission unit (transmitting unit) or a transmitter. As described above, there is no particular limitation on the method of implementation.

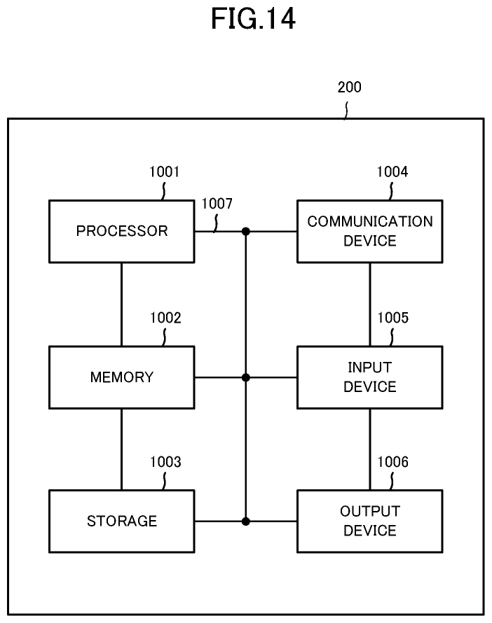

Further, the UE 200 may function as a computer that performs processing of the radio communication method of the present disclosure. FIG. 14 is a diagram showing an example of a hardware configuration of the apparatus. As shown in FIG. 14, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. The hardware configuration of the device may be configured to include one or more of the devices shown in the figure, or may be configured to exclude some of the devices.

Each functional block of the device (see FIG. 4) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 operates, for example, an operating system to control the entire computer. Processor 1001 may comprise a central processing unit (CPU) including interfaces to peripheral devices, controllers, arithmetic units, registers, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Further, the various processes described above may be executed by one processor 1001, or may be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, or the like. The memory 1002 may store programs (program codes), software modules, and the like that are capable of executing the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Devices such as the processor 1001 and the memory 1002 are connected by a bus 1007 for communicating information. The bus 1007 may be configured using a single bus or may be configured using different buses for each device.

In addition, the device may comprise hardware such as a microprocessor, a digital signal processor (DSP), an application specific integrated circuit (ASIC), a programmable logic device (PLD), a field programmable gate array (FPGA), and the hardware may implement some or all of each functional block. For example, the processor 1001 may be implemented by using at least one of these hardware.

Further, the notification of the information is not limited to the mode/embodiment described in the present disclosure, and other methods may be used. For example, notification of information may be performed by physical layer signaling (e.g., Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or a combination thereof. The RRC signaling may also be referred to as an RRC message, for example, an RRC Connection Setup message, an RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, and the like of each aspect/embodiment described in the present disclosure may be changed in order as long as there is no contradiction. For example, the methods described in this disclosure use an exemplary sequence to present the elements of the various steps and are not limited to the particular sequence presented.

The specific operation that is performed by the base station in the present disclosure may be performed by its upper node in some cases. In a network comprising one or more network nodes having a base station, it is apparent that various operations performed for communication with a terminal may be performed by the base station and at least one of other network nodes (For example, but not limited to MME or S-GW) other than the base station. In the above, an example in which there is one network node other than the base station is explained; however, a combination of a plurality of other network nodes (for example, MME and S-GW) may be used.

Information and signals (information, etc.) can be output from an upper layer (or a lower layer) to a lower layer (or an upper layer). It may be input and output via a plurality of network nodes.

The input/output information can be stored in a specific location (for example, a memory) or can be managed in a management table. The input and output information may be overwritten, updated, or appended. The information can be deleted after outputting. The inputted information can be transmitted to another device.

The determination may be made by a value represented by one bit (0 or 1), by a Boolean value (Boolean: true or false), or by a comparison of numerical values (For example, comparison with a given value).

Each of the aspects/embodiments described in the present disclosure may be used alone, in combination, or may be switched upon implementation. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, if software is transmitted from a website, server, or other remote source using at least one of wired (Coaxial cable, fiber-optic cable, twisted-pair, digital subscriber line (DSL), etc.) and wireless (Infrared, microwave, etc.) technologies, at least one of these wired and wireless technologies is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltages, currents, electromagnetic waves, magnetic fields or magnetic particles, optical fields or photons, or any combination thereof.

It should be noted that terms described in this disclosure and terms necessary to understand this disclosure may be replaced with terms having the same or similar meaning. For example, at least one of the channel and the symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station may house one or more (For example, three) cells, also referred to as sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a portion or the entire coverage area of at least one of a base station and a base station subsystem performing communication services in this coverage.

In the present disclosure, the terms “mobile station (Mobile Station: MS)”, “user terminal”, “user equipment (User Equipment: UE)”, “terminal” and the like can be used interchangeably.

A mobile station may be referred to by one skilled in the art as a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user agent, a mobile client, a client, or some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, planes, etc.), an unmanned mobile body (Drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal). For example, each aspect/embodiment of the present disclosure may be applied to a configuration in which communication between a base station and a mobile station is replaced with communication between a plurality of mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”.). For example, terms an uplink channel, a downlink channel, or the like may be read as a side channel.

Similarly, the mobile station in the present disclosure may be read as a base station. In this case, the base station may have the function of the mobile station.

The radio frame may comprise one or more frames in the time domain. Each frame or frames in the time domain may be referred to as a sub-frame.

The subframe may further comprise one or more slots in the time domain. The subframe may be a fixed time length (For example, 1 ms) independent of the numerology.

Numerology may be a communication parameter applied to at least one of transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may comprise one or more symbols (Orthogonal Frequency Division Multiplexing (OFDM)) symbols, single carrier frequency division multiple access (SC-FDMA) symbols, etc.) in the time domain. A slot may be a unit of time based on the numerology.

A slot may include a plurality of minislots. Each minislot may comprise one or more symbols in the time domain. A minislot may also be called a subslot. A minislot may be composed of fewer symbols than slots. A PDSCH (or PUSCH) transmitted in time units larger than the minislot may be referred to as a PDSCH (or PUSCH) mapping type A. A PDSCH (or PUSCH) transmitted using a minislot may be referred to as a PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be referred to as the transmission time interval (TTI), a plurality of consecutive subframes may be referred to as TTI, and one slot or one minislot may be referred to as TTI. That is, at least one of the sub-frame and TTI may be a sub-frame (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (That is, one or more slots or one or more minislots) may be the minimum time unit for scheduling. The number of slots (minislot number) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. A TTI shorter than a normal TTI may be referred to as a shortened TTI, a short TTI, a partial or fractional TTI, a shortened subframe, a short subframe, a minislot, a subslot, a slot, or the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and the frequency domain, and may include one or more continuous subcarriers in the frequency domain. The number of subcarriers included in RB may be, for example, twelve, and the same regardless of the topology. The number of subcarriers included in the RB may be determined based on the neurology.

The time domain of the RB may also include one or more symbols and may be one slot, one minislot, one subframe, or one TTI in length. The one TTI, one subframe, and the like may each comprise one or a plurality of resource blocks.

The one or more RBs may be referred to as a physical resource block (PRB), a sub-carrier group (SCG), a resource element group (REG), a PRB pair, an RB pair, or the like.

The resource block may comprise one or more resource elements (REs). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or more BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes contained in a radio frame, the number of slots per subframe or radio frame, the number of minislots contained in a slot, the number of symbols and RBs contained in a slot or minislot, the number of subcarriers contained in an RB, and the number of symbols, symbol length, and cyclic prefix (CP) length in a TTI may be varied in various ways.

The term “connected”, “coupled”, or any variation thereof, refers to any direct or indirect connection or coupling between two or more elements and may include the presence of one or more intermediate elements between two elements that are “connected” or “coupled” to each other. The coupling or connection between the elements may be physical, logical, or a combination thereof. For example, “connection” may be read as “access”. As used in the present disclosure, the two elements may be considered to be “connected” or “coupled” to each other using at least one of one or more electrical wires, cables and printed electrical connections and, as some non-limiting and non-comprehensive examples, electromagnetic energy having wavelengths in the radio frequency region, microwave region and light (both visible and invisible) region.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to elements using the designation “first,” “second,” etc., as used in this disclosure does not generally limit the amount or order of those elements. Such designations can be used in the present disclosure as a convenient way to distinguish between two or more elements. Thus, references to the first and second elements do not imply that only two elements may be employed therein, or that the first element must in some way precede the second element.

In the present disclosure, the used terms “include”, “including”, and variants thereof are intended to be inclusive in a manner similar to the term “comprising”. Furthermore, the term “or” as used in this disclosure is not intended to be an exclusive OR.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “decision” may include regarding some action as “judgment” or “decision”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
200 UE
210 Radio signal transmission/reception unit
220 Amplifier unit
230 Modulation/demodulation unit
240 Control signal/reference signal processing unit
250 Encoding/decoding unit
260 Data transmission/reception unit
270 Control unit
1001 Processor
1002 Memory
1003 Storage
1004 Communication device
1005 Input device
1006 Output device
1007 Bus

1. A terminal comprising:
a control unit that multiplexes uplink control information on an uplink shared channel; and
a communication unit that transmits an uplink signal using the uplink shared channel on which the uplink control information is multiplexed; wherein
the control unit multiplies a number of bits constituting the uplink control information by a coefficient in a rate matching of the uplink control information, and
the control unit applies, as a range of coefficient, a specific range corresponding to a combination of a priority of the uplink control information and a priority of the uplink shared channel.

2. The terminal according to claim 1, wherein
the control unit applies the specific range corresponding to the number of bits of the uplink control information.

3. The terminal according to claim 1, wherein
the control unit applies the specific range corresponding to a type of the uplink control information.

4. The terminal according to claim 1, wherein
the control unit applies the specific range based on a radio resource management message or downlink control information.

5. The terminal according to claim 1, wherein
the control unit applies the specific range based on a capability of the terminal.

6. The terminal according to claim 2, wherein
the control unit applies the specific range corresponding to a type of the uplink control information.

7. The terminal according to claim 2, wherein
the control unit applies the specific range based on a radio resource management message or downlink control information.

8. The terminal according to claim 3, wherein
the control unit applies the specific range based on a radio resource management message or downlink control information.

9. The terminal according to claim 2, wherein
the control unit applies the specific range based on a capability of the terminal.

10. The terminal according to claim 3, wherein
the control unit applies the specific range based on a capability of the terminal.

11. The terminal according to claim 4, wherein
the control unit applies the specific range based on a capability of the terminal.
